(19) United States
(12) Patent Application Publication
(10) Pub. No.: US 2025/0345928 A1
(43) Pub. Date: Nov. 13, 2025

(54) POSITIONING MODULE, AND POSITIONING APPARATUS HAVING SUCH A POSITIONING MODULE

(71) Applicant: PHYSIK INSTRUMENTE (PI) GMBH & CO. KG, Karlsruhe (DE)

(72) Inventors: Thomas HAASE, Steinweiler (DE); Stefan SCHULZ, Pfinztal (DE); Stephanie STREIT, Karlsruhe (DE)

(21) Appl. No.: 18/835,967

(22) PCT Filed: Feb. 3, 2023
(86) PCT No.: PCT/DE2023/100087

§ 371 Date: May 5, 2025

(30) Foreign Application Priority Data
Feb. 7, 2022 (DE) I0 2022 102 732.5

(51) Int. Cl. B25J 9/14; B25J 9/00; B25J 19/00

(52) U.S. Cl. CPC B25J 9/146; B25J 9/0021; B25J 19/0012; B25J 19/0025

(57) ABSTRACT

The invention relates to a positioning module (1) with a base (2) and a positioning element (3) that is movable relative to the base (2), wherein the positioning element (3) is coupled to the base (2) via a leg element (4) of constant length, and the leg element (4) is connected to the positioning element (3) via a joint device (5), and the leg element (4) is assigned a drive module (6) arranged on the base with a drive unit (62), with a drive element (64) that is displaceable along a direction of movement by the drive unit (62), which is connected to the leg element (4) via a joint device (5), and with a force compensation device (7) connected to the drive element (64), wherein a defined force can be exerted on the drive element (64) along the direction of movement of the drive element (64) by means of the force compensation device (7).

The invention relates to a positioning module according to claim 1 and a positioning device with at least one such positioning module according to claim 10.

A positioning device is known from the applicant's publication DE 10 2019 111 026 B4, in which a positioning element can be positioned in six degrees of freedom relative to a base by means of length-adjustable and electrically driven leg elements.

A certain disadvantage of the positioning device known from DE 10 2019 111 026 B4 is the comparatively large installation space occupied by the leg elements and the mechanical load on the drives integrated in the leg elements caused by forces, in particular weight and load forces. Another certain disadvantage of the positioning device known from DE 10 2019 111 026 B4 is its limited range of operational range.

The present invention is based on the object of providing a versatile positioning module which occupies a small installation space and in which loads on the drive due to external forces such as load or weight forces can be reduced.

This object is solved by a positioning module according to claim 1, with the subsequent subclaims describing at least useful further embodiments.

The positioning module according to the invention comprises a base and a positioning element that can be moved relative to the base. The positioning element is coupled to the base via at least one leg element of constant length or non-variable length, the leg element being connected to the positioning element via an joint device. A separate drive module is assigned to each leg element, i.e. the leg element or each leg element has its own drive module. The drive module is disposed at the base and comprises a drive unit and a drive element displaceable along a direction of movement by the drive unit. The drive element is connected to the associated leg element via a further joint device so that each of the leg elements can be moved separately in case that there are several leg elements. The drive element is connected to a force compensation device with which a defined force can be exerted on this drive element along the direction of movement of this drive element.

If the indefinite article is used for a feature in the text—as above and, where applicable, also below—then in a subsequent mention of the same feature, explicit reference is made to the quantity information implied by the indefinite article by using the definite article, without this being intended to lead to a corresponding restriction to precisely this quantity information. In this context, with reference to the positioning module described above, this is also intended to include, among other things:
in the case of several leg elements, either only some of the leg elements or all leg elements are connected to the positioning element via an joint device
in the case of several leg elements, each leg element is assigned a separate drive module arranged on the base
in the case of several leg elements and correspondingly several drive elements, either only some of the drive elements are connected to the respective leg element via an joint device or all drive elements are connected to the leg elements via an joint device
in the case of several leg elements and a corresponding number of drive modules or drive elements, either only some of the drive elements are connected to a respective force compensation device, or all of the drive modules or drive elements are connected to a respective force compensation device.

The fact that the drive module and the corresponding drive unit of a leg element are arranged on the base and act on the joint device connected to the drive element, i.e. move the joint device, results in a so-called foot point movement of the leg element, which itself is invariable in length or constant in length. This means that the joint device facing the base does not have to bear the weight of the drive and can therefore be lighter, i.e. less massive.

Furthermore, the leg element or the leg elements can be designed to be significantly more delicate and also lighter, so that overall a weight-reduced and space-optimized design for the positioning module according to the invention is possible. Due to the additional force compensation device, which is connected to the drive element, the introduction of forces, in particular load and weight forces, into the drive unit can either be completely prevented or at least significantly reduced.

A positioning module according to the invention, which can be used on its own as a 2d planar positioning device or 2d planar adjuster, can be supplemented by further positioning modules according to the invention in order to obtain a positioning device optimized for the respective application (modular design). For example, a 4d adjuster can be realized with two of the positioning modules according to the invention.

It may be advantageous that the force compensation device comprises or one of the force compensation devices comprise at least one force compensation module, and that the at least one force compensation module is connected to the base. This enables a particularly space-saving or integrated design of the positioning module. The above should also include a positioning module in which, in the case of several force compensation devices, only one of the force compensation modules, or several of the force compensation modules, or all of the force compensation modules are connected to the base. It should also be included that, in the case of several force compensation devices, these each comprise a different number of force compensation modules.

It can also be advantageous that the defined force, which acts on the respective drive element by means of the force compensation device or one or more of the force compensation devices or all of the force compensation devices, is generated by magnets or by compressed air or by pressurized fluid. With regard to the use of magnetic forces for force compensation, electromagnets or a combination of permanent and electromagnets are conceivable in addition to permanent magnets.

It can also be advantageous that the force compensation module or one or more of the force compensation modules or all of the force compensation modules comprises or comprise a sleeve made of a material, which is magnetic or magnetizable at least in a section, and a rod made of a material which is magnetic or magnetizable at least in sections and which projects at least partially into the sleeve, the sleeve and the rod each being mounted so that they can rotate relative to one another. It can be of particular advantage here that two shell segments or hollow cylinder segments made of a magnetic or magnetizable material are inserted into the sleeve of the force compensation module, and said shell or hollow cylinder segments span an angle of essentially 90 degrees. This allows a comparatively simple realization of an adjustable or variable force compensation by means of magnetic forces.

It may also be advantageous the force compensation device comprises or one or more of the force compensation devices comprise or all of the force compensation devices comprise a lever transmission device. A lever transmission can also be used to compensate for higher loads that would otherwise act on or be introduced into the drive.

Furthermore, it may be advantageous that the drive unit comprises or one or more of the drive units comprise or all of the drive units to comprise an electromagnetic drive. Voice coil direct drives, for example, have the advantage that they operate without friction and allow high dynamics. They also allow greater positioning precision and are more cost-effective than spindle drives, for example.

Furthermore, it may be advantageous that at least one of the two joint devices associated with a leg element is designed in such a way that tilting of this leg element about two tilting axes arranged perpendicular to one another and rotation of the same leg element about its own longitudinal axis is possible. It can be advantageous here that at least one of the joint devices comprises a cardan joint and a swivel joint, wherein the aforementioned joint types can be designed with surfaces of the corresponding joint elements or joint sections that is displaceable or moved relative to each other and thereby rub or slide against each other in the sense of conventional cardan or swivel joints, or the aforementioned joint types can be formed by a solid-state joint or several interacting solid-state joints or by a combination of conventional and solid-state joints. The two tilting options of a leg element provided by a cardan joint coupled with the twisting or rotation option provided by a swivel joint allow, in particular, the realization of a positioning element with six degrees of freedom.

The invention also relates to a positioning device for positioning an object with at least one positioning module as outlined above. It can be particularly advantageous here that the positioning device has three positioning modules, wherein each of the positioning modules comprises two leg elements forming a pair of legs, wherein the positioning modules are arranged relative to one another in such a way that in each case one pair of legs protrudes through another pair of legs and each pair of legs is arranged perpendicular to the respective other pairs of legs, and wherein the positioning element of each positioning module is connected to the positioning elements of the two respective other positioning modules and the three positioning elements together form a positioning body which comprises six degrees of freedom of movement.

Here, it may be advantageous that each of the positioning elements corresponds to a platform with a substantially planar platform surface, wherein the respective platform assigned to a pair of legs is arranged substantially perpendicular to the leg elements thereof, and wherein the three interconnected platforms together form a positioning body in which each of the platform surfaces is arranged substantially perpendicular to the other two respective platform surfaces, thereby forming part of a cube or a partial cube.

In addition, it can be advantageous here that the three positioning modules are arranged such that their bases together form a cube-like base body with an essentially cube-shaped recess, and that the partially cube-shaped positioning body is arranged within this cube-shaped recess such that the respective corresponding edges of the base body and the positioning body run parallel to one another and the positioning body essentially completes the base body to form a complete cube. The corresponding arrangement of the positioning body in a corner of the cube-shaped base body results in a working point in the same corner of the base body in an analogous manner, which results in a maximized working space. This is in contrast to conventional hexapods, where the working point is in the center of a working platform. This working point can be moved symmetrically in all spatial directions and rotated around all spatial axes. If translational and rotational movements are to be carried out around a different working point, a transformation back to the original working point is necessary (mathematical back calculation). This means that the full travel or positioning angle is not possible at the new operating point. However, as many applications have an operating point that is not in the center of the working platform but at an edge, the operating range of conventional hexapods is severely restricted.

Advantages and usefulness of the invention will become clearer from the following description of preferred embodiments with reference to the figures, which show:

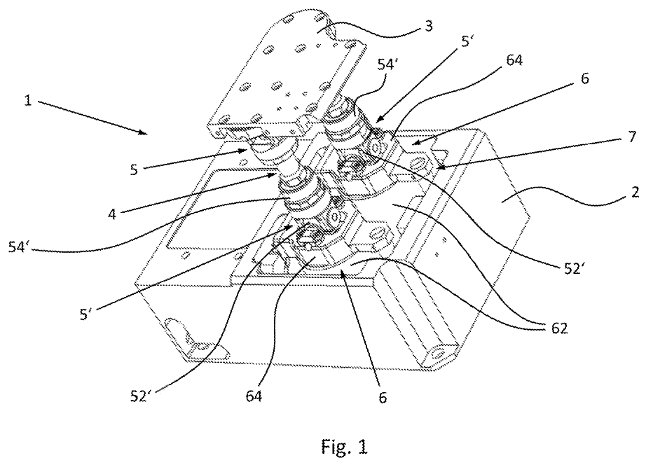

FIG. 1: Perspective view of a positioning module according to the invention with two leg elements

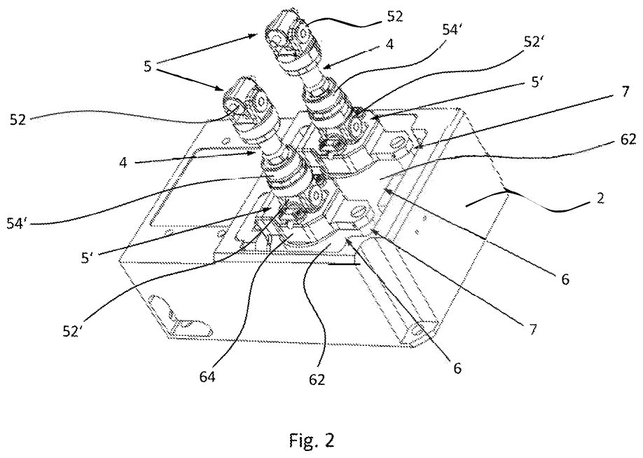

FIG. 2: Representation of the positioning module according to FIG. 1 without positioning element

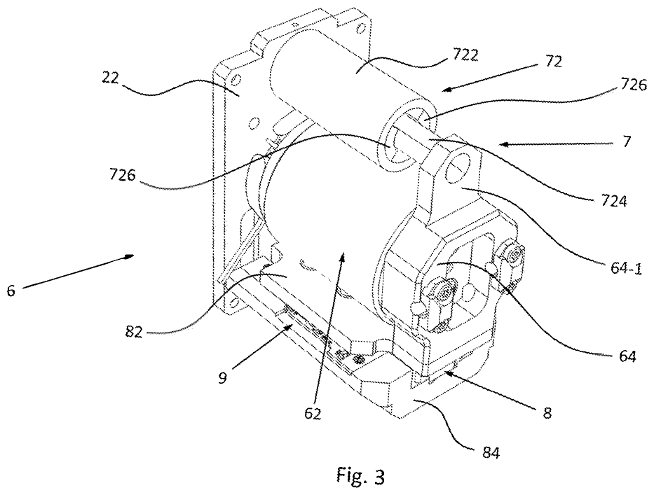

FIG. 3: Perspective view of a single drive module of the positioning module according to FIG. 1 and FIG. 2

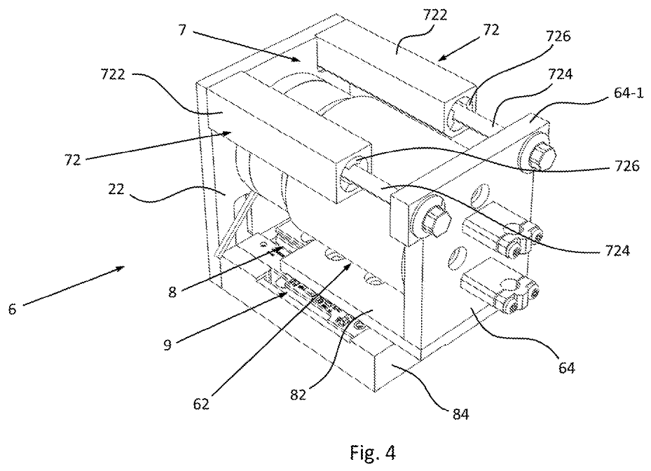

FIG. 4: Perspective view of a single drive module for a positioning module according to the invention with an alternative embodiment for the force compensation device

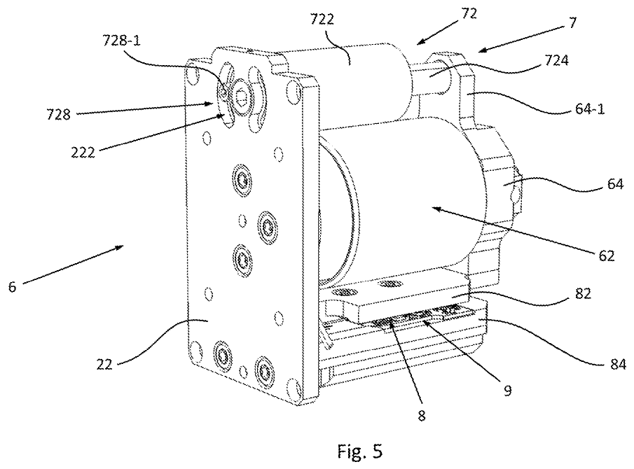

FIG. 5: Perspective view of the drive module according to FIG. 3 with different viewing directions

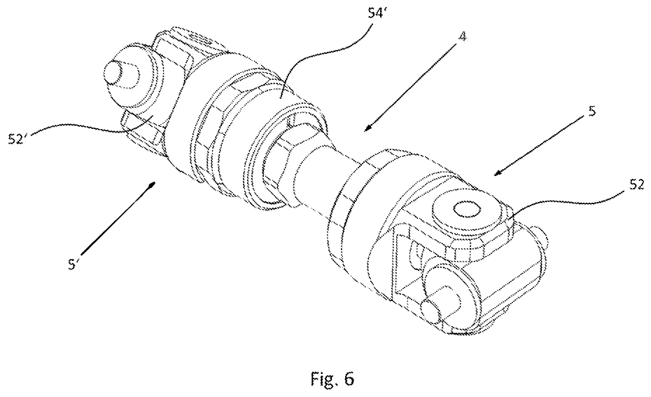

FIG. 6: Perspective view of a leg element of a positioning module with joint elements arranged thereon

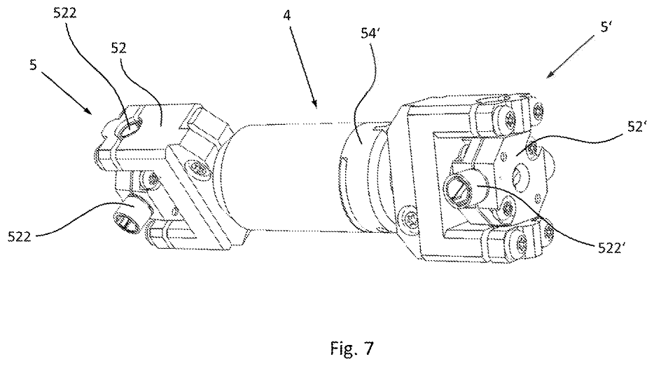

FIG. 7: Perspective view of a leg element of a positioning module with joint devices arranged thereon in the form of solid-state joints

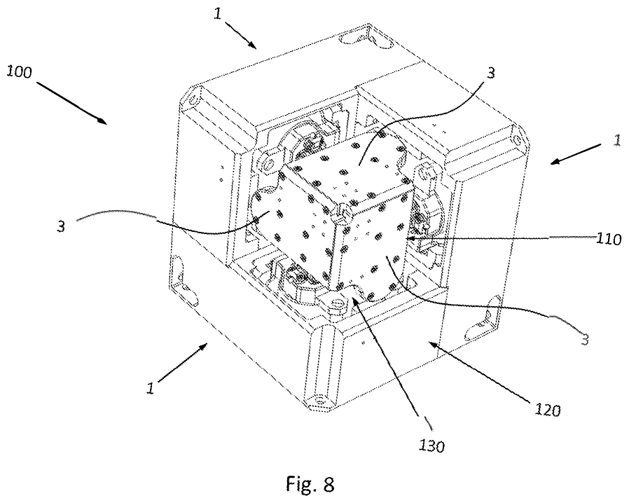

FIG. 8: Positioning device with a total of three positioning modules according to FIG. 1 in the form of a hexapod or hexapod cube

FIG. 1 shows a perspective view of an embodiment of a positioning module 1 according to the invention. Two drive modules 6, each with a drive unit 62 in the form of a linear direct drive, realized by a single-phase voice coil motor (VCM), are located in a recess or cut-out of a base 2, are arranged next to or behind one another and are independent of one another, wherein each of the two drive modules 6 is indirectly connected to the base 2 via a base plate not visible in FIG. 1. In its most general form, the positioning module 1 can comprise only one drive module 6. The drive unit 62 is not limited to direct drives and also not limited to VCM or a single-phase VCM. It is conceivable to use a three-phase linear motor as an alternative, which allows greater actuating travel. It is also conceivable to realize the drive unit 62 via a spindle driven by an electric motor, with which high drive forces can be realized and which also has effective self-locking properties. Self-locking in general means the resistance caused by friction against slipping or twisting of two bodies lying against each other, and in connection with drives the corresponding resistance against unintentional adjustment or movement of the drive element, in particular in the de-energized state of the drive unit.

Furthermore, piezomotors in the form of stepping drives, ultrasonic drives or stick-slip or inertial drives are possible for the drive unit, which also have self-locking properties. In addition, drive units in the form of actuators based on different actuator principles are also conceivable, such as hydraulic or pneumatic actuators, electromechanical actuators, shape memory alloy actuators, etc. It is conceivable that the actuating movement of the actuators can be increased via lever transmission devices.

Each of the two drive units 62 comprises a drive element 64, which represents the (linearly) movable part of the respective drive unit 62. The drive element 64 is guided linearly via a guide device arranged outside the drive unit 62 and to the side thereof, which is concealed in FIG. 1 and is therefore not or only insufficiently recognizable. However, it is also conceivable to use a centrally arranged guide device in the form of a guide sleeve. It is also possible to equip or connect the corresponding guide device with a lever transmission.

Via a connecting section 64-1 protruding or projecting laterally from the respective drive element 64, the latter is connected to a force compensation device 7, which is described in more detail below. The force compensation device 7 is particularly suitable for minimizing, completely eliminating or even overcompensating for load forces, and in particular weight forces, acting on the drive element 64, in particular in a direction towards the drive unit 62, i.e. for generating a greater force than the load forces acting on the drive element 64, essentially in a direction opposite to the direction of the load forces. In this way, disadvantageous effects due to mounting orientations of the positioning module 1 (for example standing, hanging from a ceiling or hanging on a wall) can be reduced or even eliminated. This is particularly advantageous for positioning modules whose drive unit or drive units have little or no self-locking, so that energy must be applied to hold a certain position of the drive element 64 when external forces act on it, resulting in a power loss that can lead to undesired heating of the positioning module 1. Self-locking is particularly important if the energy source for driving the drive element 64 is removed.

A first joint device 5′ is arranged on each of the two drive elements 64, which is a combination of a universal joint 52′ and a swivel joint 54′, wherein both joints are designed in such a way that bearing surfaces or corresponding sections of the joints move against each other during a joint movement and are, so to speak, classic or conventional joint elements. It is also conceivable to provide only one universal joint for each joint device 5′. In addition, one or each joint device 5′ can also comprise other joint shapes, for example a ball joint, or combinations of different joint shapes.

An essentially cylindrical leg element 4 is connected to each of the joint devices 5′, which is purely passive and constant in length or unchangeable in length. The two leg elements 4 together form a leg pair 40, and a corresponding leg pair plane is spanned by the two central axes of the leg elements 4.

At the end of each leg element 4 facing away from the base, a second joint device 5 is connected, which is constructed in each case as a universal joint 52, which is designed identically to the universal joint 52′ of the joint device 5′ of the same leg element 4. Unlike the first joint device 5′, the second joint device 5 of the same leg element 4 does not comprise a swivel joint.

In FIG. 1, the joint devices 5 are partially or completely concealed by the positioning element 3 arranged on them and are therefore difficult or impossible to recognize. For better recognizability, please refer to FIG. 2. While, as explained above, the joint devices 5, 5′ of a leg element differ from one another in that the joint device 5′ comprises both a universal joint and a swivel joint, while the joint device 5 comprises only a universal joint, it is conceivable that the joint devices 5, 5′ of a leg element 4 are completely identical to one another. It is also conceivable that the joint devices 5 differ from the joint devices 5′ in terms of shape, size and material. It is also conceivable to use other types of joint, such as a ball joint, for the joint devices 5, 5′.

Due to the joint devices 5 and 5′ arranged at both end sections of each leg element 4, each leg element 4 can perform tilting about two axes of rotation arranged perpendicular to each other, as well as rotations about its longitudinal axis arranged perpendicular to the two axes of rotation responsible for the tilting.

Connected to the two articulated devices 5 is a substantially plate-shaped and flat positioning element 3, which is provided with holes or threaded holes for fastening an element to be positioned by means of the positioning module thereto. For the positioning or adjustment of the positioning element 3, either one or the other drive unit 62 or both drive units 62 are actuated together, so that either only one of the two drive elements 64 performs a linear movement or both drive elements 64 perform a linear movement together, the directions of which can be in the same direction or opposite to each other. The linear movements of the drive elements 64 cause corresponding movements of the joint devices 5 connected thereto, so that the respective end sections of the leg elements connected to the joint devices 5 are moved. In this context, one also speaks of a base point movement of the leg elements 4. Since the leg elements 4 are constant in length or unchangeable in length, the distance between the joint devices 5, 5′ arranged at both end sections of the same also remains constant during the resulting movement of the leg elements 4.

FIG. 2 is almost identical to FIG. 1; the only difference is that in FIG. 2 the positioning element 3 has been omitted from the positioning module so that the joint devices 5 can be better recognized. Due to the otherwise identical nature of FIGS. 1 and 2, the features in FIG. 2 are not described and reference is made to the description of FIG. 1.

FIG. 3 shows a single drive module 6 of the positioning module according to FIG. 1 or FIG. 2. Here, the drive unit 62 of the drive module 6 is firmly connected to a base plate 22 by means of screws not visible in FIG. 3, which in turn is firmly connected to the base 2 by means of screws. The drive element 64, which is moved linearly by the drive unit 62 in the form of a 1-phase VCM, is coupled via a connecting section 64-1 to a force compensation module 72 of a force compensation device 7, the force compensation module 72 being firmly connected to the base plate 22. The force compensation module 72 comprises a hollow cylindrical sleeve 722 made of a magnetically conductive metal, on the inner circumferential surface or inner wall of which two permanent magnets 726 in the form of shell segments or hollow cylinder segments are provided, offset along the circumferential direction and arranged opposite one another, each hollow cylinder segment substantially spanning a circular angle of 90 degrees. It is conceivable to use shell or hollow cylinder segments that span a circular angle that deviates from 90 degrees. It is also conceivable to use more than two shell or hollow cylinder segments made of a permanent magnetic material.

A cylindrical rod 724 made of a permanent magnetic material and flattened on two opposite sides is partially immersed in the substantially cylindrical cavity formed by the shell segments within the sleeve 722, wherein the rod 724 is fixedly connected to the connecting portion 64-1 of the drive element 64 and moved therewith.

Due to the magnetic interaction between the permanent magnets 726 and the rod 724, which is partially immersed therein or arranged in sections therebetween, a force is generated which, depending on the orientation of the permanent magnets 726 and the rod 724 relative to one another, points either in a direction towards the base plate 22 or in a direction away from the base plate. Depending on the application and thus depending on the spatial orientation or alignment of the respective drive module 6 or the drive unit 62, the above-mentioned orientation of the permanent magnets 726 and the rod 724 relative to one another, which is adjustable, the adjustability of which being discussed in more detail below, can be used to ensure that, for example, weight forces acting on the drive unit 62 via the drive element 64 are reduced, canceled out or even overcompensated.

It is not necessarily required to use permanent magnets 726 for the elements inserted into the sleeve 722; elements made of magnetizable materials are also conceivable for this purpose. Conversely, if permanent magnets 726 are used within the sleeve 722, the rod 724 can be made of a magnetizable material.

The drive element 64 is connected on the side opposite the connecting portion 64-1 to a guide carriage 82 of a guide device 8 in the form of a linear guide with recirculating balls. Here, the fixed part of the guide device 8 is attached to a guide base 84, which in turn is attached to the base plate 22 and is aligned substantially perpendicular to the latter. In a corresponding manner, the guide device 8 is arranged substantially perpendicular to the base plate 22, so that the guide carriage 82 is movably mounted and linearly guided along a direction which is arranged substantially perpendicular to the base plate 22. Thus, the drive element 64 connected to the guide carriage 82 is also guided linearly accordingly.

It is conceivable to use other types of linear guides instead of a guide device 8 in the form of a recirculating ball linear guide; these include, for example, cross-roller-guided linear guides, sliding guides, hydrodynamic guides, air-bearing guides or magnetically mounted guides.

The position of the drive element 64 can, for example, be determined indirectly by measuring the position of the guide carriage 82 using suitable sensors, but direct measurement of the position of the drive element 64 is also possible. Incremental or absolute encoders, for example, are conceivable for these direct or indirect position measurements. The position of the positioning element 3 can be determined using the position of the drive element or drive elements measured in this way. However, it is also possible to determine the position and orientation of the positioning element by direct measurement on the positioning element, for example using an interferometer.

Part of the sensor system can be arranged on a printed circuit board 9, which is arranged on the guide base 84 and opposite the guide carriage 82. The printed circuit board 9 can also comprise power electronics, such as the driver for the drive unit 62, and other electronic components or modules, such as the controller for the drive unit or elements used for communication. The arrangement of the printed circuit board on the guide base 84 enables an integral and space-reducing design of the drive module 6 and thus also of the positioning module 1.

It is conceivable to arrange the printed circuit board 9 at a location other than the guide base 84 of the drive module 6, for example in the recess or cut-out provided in the base 2 for accommodating the drive modules 6. It is also conceivable to accommodate only the power electronics on the printed circuit board 9, while communication electronics are accommodated on another printed circuit board or PCB, and this other printed circuit board is also arranged at a different location on the positioning module. In general, it is preferable to arrange the power electronics as far away as possible from the drive unit or drive units 62 on or in the base 2. This has the advantage that heat generated in the power electronics can be dissipated via the base 2 and is therefore not introduced into the drive unit or drive units 62, which has a positive effect on the positioning accuracy.

FIG. 4 shows a perspective view of a single drive module 6 for a positioning module according to the invention with an alternative embodiment for the force compensation device 7. Since the drive module 6 shown in FIG. 4 is very similar to that shown in FIG. 3, only the specific differences in comparison with FIG. 3 will be discussed below.

The force compensation device 7 has here—in contrast to the drive module according to FIG. 3—two force compensation modules 72, which are spaced apart and arranged parallel to one another, the respective sleeve 722 having a square outer contour when viewed in cross-section and being columnar overall. The use of two force compensation modules 7 allows the compensation of larger forces compared to the use of only one identically designed force compensation module. However, the use of two or more force compensation modules can also be useful for reasons of space, as each force compensation module can then be smaller. If more than one force compensation module 72 is used, it is conceivable that only one force compensation module or only some of the force compensation modules 72 can be adjusted with regard to the compensation force, while the other force compensation module(s) exerts a constant and non-variable compensation force.

In the interior, each sleeve 722 comprises two permanent magnets 726 arranged offset and opposite one another in the form of shell or hollow cylinder segments, which each span a circular angle of substantially 90 degrees or each extend over a circular angle of 90 degrees. Here, the two permanent magnets 726 of one force compensation module 72 are arranged offset by substantially 90 degrees relative to the permanent magnets 726 of the respective other force compensation module 72.

The essentially plate-shaped drive element 64 is firmly connected to the rod 724 of the respective force compensation module 72 via a screw connection.

FIG. 5 shows a perspective view of the drive module according to FIG. 3, but from a different viewing direction, so that the underside of the base plate 22 can be seen with corresponding details, which are not visible in FIG. 3. In the following, only these differences are discussed and reference is made to the description of FIG. 3 with regard to the remaining features.

The force compensation module 72 has an adjustment device 728, which essentially comprises two partially circular recesses 222 of the base plate 22 arranged in mirror image to one another. The head of a screw 728-1 is arranged in one of the two recesses, which rests against a web section within the corresponding recess 222 and is supported thereon. The corresponding screw 728-1, which interacts with the sleeve 722, serves to fix it in its desired orientation or position. Here, the head of the screw 728-1 is displaceable along and guided through the respective recess when the screw connection is loosened, whereby the sleeve 722 is simultaneously moved or rotated, and as soon as the desired rotational adjustment or orientation of the sleeve 722 and the permanent magnets arranged in the sleeve is achieved, the sleeve 722 is fixed by tightening the screw 728-1 and thus the position of the permanent magnets relative to the rod 724 immersed in the sleeve 722 is fixed. A defined tensile or compressive force can be set via the mutual position of the permanent magnets and the rod 724, which acts on the drive element 64 due to the fixed connection of the rod 724 to the latter and, in accordance with the set force direction, pulls the drive element 64—in the case of a tensile force—in a direction towards the drive unit 62 or in a direction towards the base plate 22 or pushes the drive element 64—in the case of a compressive force—in a direction away from the drive unit 62 or from the base plate 22.

Other ways of adjusting the compensation force of a force compensation module 7 are conceivable. The adjustment can be made from the rear side according to FIG. 5 or from the front side according to FIG. 4. In addition, the sleeve 722 can be rotated according to FIG. 5 or the rod 724 according to FIG. 4. It is also conceivable to integrate a rotary motor that can move the rod 724 or the sleeve 722. The rotary motor can then, for example, receive the motor current of a VCM as an input and thus rotate the rod or the sleeve until the motor current of the VCM is minimized.

FIG. 6 shows a perspective view of the isolated leg element 4 of the positioning module 1 according to FIG. 1 or FIG. 2 with the joint devices 5 and 5′ arranged thereon. While the joint device 5′ provided for the arrangement on the drive element comprises a combination of a cardan joint 52′ and a swivel joint 54′, the joint device 5 provided for the connection to the positioning element 3 comprises only a universal joint 52. However, it is conceivable that the joint device 5 also comprises a swivel joint, so that the joint devices 5 and 5′ on the leg element 4 have a mirror-image structure. As already mentioned, other joint types can be used for one of the joint devices 5, 5′ or for both joint devices 5, 5′ of a leg element 4, for example ball joints.

FIG. 7 shows a perspective view of a leg element 4 for a positioning module according to the invention, in which the joint devices arranged thereon have the form of solid-state joints. The joint device 5 is designed as a cardan joint 52 and comprises two solid-state swivel joints 522, the axes of which cross at a right angle. The joint device 5′, on the other hand, comprises a cardan joint 52′, which is identical in design to the cardan joint 52, and a swivel joint 54′, which is designed as a solid-state joint and adjoins the cardan joint 52′ in a direction towards the cardan joint 52.

A positioning device 100 with a total of three positioning modules 1 according to FIG. 1 in the form of a hexapod or a hexapod cube is shown in FIG. 8. Each of the three positioning modules 1 comprises two leg elements 4 forming a pair of legs. The positioning modules 1 are arranged relative to each other in such a way that one pair of legs protrudes through another pair of legs and each pair of legs is arranged perpendicular to the other pairs of legs.

The respective positioning element 3 assigned to a pair of legs corresponds to a platform with a substantially flat platform surface, wherein the platform or the platform surface is arranged substantially perpendicular to the leg elements 4 of the respective positioning module 1.

Each of the total of three positioning elements 3 is connected to the two respective other positioning elements 3 in such a way that the three positioning elements 3 together form a positioning body 110, in which each of the platform surfaces is arranged substantially perpendicular to the two respective other platform surfaces and thus forms part of a cube or hollow cube. Due to the arrangement of the positioning modules 1 relative to one another and the structure of each individual positioning module 1, six degrees of freedom of movement result for the positioning body 110.

The three positioning modules 1 are arranged relative to one another in such a way that the same or their bases 2 together form a cube-like base body 120, which comprises a substantially cube-shaped recess 130 in one of its corners. Within this recess 130, the partial-cube-shaped positioning body 110 is arranged in such a way that the partial-cube-shaped positioning body 110 fills the recess 130 in such a way that it almost completes the cube-like base body 120 to form a complete cube or hexapod cube, wherein the respective corresponding edges of the base body 120 and the positioning body 110 running parallel to one another or wherein the corresponding edges of the positioning body 110 correspond to an extension of the respective edges of the base body 120.

In other words, the positioning body 110 forms a smaller cube or the contours of a smaller cube, which is arranged in a corner point of the larger cube-like base body 120. Therefrom identical edge lengths of the cube or hexapod cube resulting from the combination of the positioning body 110 and the base body 120 result, whereby absolute symmetry results. This ensures that the range of movement of the positioning body 110, which starts at one edge of the cube, is the same in all directions. The operating point, also known as the pivot point, is therefore located at a corner of the hexapod cube. This offers numerous advantages over a hexapod in which the working point is located in the center of the working platform, as already described above.

The symmetrical structure of the Hexapod cube enables any installation, e.g. hanging, standing, etc., without restrictions in terms of access, working area, etc. For example, it is possible to screw several hexapod cubes together or place them so close to each other that all hexapod cubes can act on the same workpiece. Furthermore, due to its symmetry, the hexapod comprises three identical work surfaces offset by 90 degrees to each other, on which any tools can be mounted.

List of reference symbols

| | |
|---|---|
| 1 | positioning module |
| 2 | base |
| 22 | base plate |
| 222 | recesses (of the base plate 22) |
| 3 | positioning element |
| 4 | leg element |
| 5, 5′ | joint device |
| 52, 52′ | cardan joint (of the joint device 5, 5′) |
| 522, 522′ | solid body swivel joint (of the cardan joint 52, 52′) |
| 54, 54′ | swivel joint (of the joint device 5, 5′) |
| 6 | drive module |
| 62 | drive unit (of the drive module 6) |
| 64 | drive element (of the drive unit 62) |
| 64-1 | connecting section (of the drive element 64) |
| 7 | force compensation device |
| 72 | force compensation module (of the force compensation |
| | device 7 |
| 722 | sleeve (of the force compensation module 72) |
| 724 | rod (of the force compensation module 72) |
| 726 | permanent magnets (of the force compensation module 72) |
| 728 | adjustment device (of the force compensation module 72) |
| 728-1 | screw (of the adjustment device 728) |
| 8 | guide device |
| 82 | guide carriage (of the guide device 8) |
| 84 | guide base (of the guide device 8) |
| 9 | printed circuit board |
| 100 | positioning device |
| 110 | positioning body (of the positioning device 100) |
| 120 | base body (of the positioning device 100) |
| 130 | recess (of the base body 120). |

1-13. (canceled)

14. A positioning module with a base and a positioning element which is movable relative to the base, wherein the positioning element is coupled to the base via a leg element of constant length, and wherein the leg element is connected to the positioning element via a joint device, and wherein the leg element is assigned a drive module arranged on the base, wherein the drive module comprises a drive unit, a drive element that is displaceable along a direction of movement by the drive unit, which is connected to the leg element via a joint device, and a force compensation device connected to the drive element, wherein a defined force along the direction of movement of the drive element can be exerted on the latter by means of the force compensation device.

15. The positioning module according to claim 14, wherein the defined force which acts on the drive element by means of the force compensation device is generated by magnets or by compressed air or by hydraulic fluid.

16. The positioning module according to claim 14 wherein the force compensation device comprises a force compensation module which is directly or indirectly connected to the base.

17. The positioning module according to claim 16, wherein the defined force which acts on the drive element by means of the force compensation device is generated by magnets or by compressed air or by hydraulic fluid.

18. The positioning module according to claim 16, wherein the force compensation module comprises a sleeve made of a magnetic or magnetizable material and a rod made of a magnetic or magnetizable material which extends at least partially into the sleeve, the sleeve and the rod each being mounted so as to be rotatable relative to one another.

19. The positioning module according to claim 16, wherein the defined force which acts on the drive element by means of the force compensation device is generated by magnets or by compressed air or by hydraulic fluid and wherein the force compensation module comprises a sleeve made of a magnetic or magnetizable material and a rod made of a magnetic or magnetizable material which extends at least partially into the sleeve, the sleeve and the rod each being mounted so as to be rotatable relative to one another.

20. The positioning module according to claim 14, wherein the force compensation device comprises a lever transmission device.

21. The positioning module according to claim 14, wherein the drive unit comprises an electromagnetic drive.

22. The positioning module according to claim 14, wherein at least one of the joint devices is designed in such a way that a tilting of the leg element about two tilting axes arranged perpendicular to one another and a rotation of the same leg element about its own longitudinal axis is possible.

23. The positioning module according to claim 22, wherein the at least one joint device is designed as a solid-state joint.

24. The positioning module according to claim 22, wherein the at least one joint device comprises a cardan joint and a rotary joint.

25. The positioning module according to claim 24, wherein the at least one joint device is designed as a solid-state joint.

26. The positioning device according to claim 14 for positioning an object with at least one positioning module according to.

27. The positioning device according to claim 26 with three positioning modules, each of the positioning modules having two leg elements forming a pair of legs, the positioning modules being arranged relative to one another in such a way that one pair of legs extends through another pair of legs and each pair of legs is arranged perpendicular to the other pairs of legs, and the positioning element of each positioning module is connected to the positioning elements of the respective two other positioning modules and the three positioning elements together form a positioning body which comprises six degrees of freedom of movement.

28. The positioning device according to claim 27, wherein each of the positioning elements corresponds to a platform with a substantially flat platform surface, wherein the respective platform assigned to a pair of legs is arranged substantially perpendicular to its leg element, and wherein the three platforms which are interconnected with each other together form a positioning body in which each of the platform surfaces is arranged substantially perpendicular to the other two platform surfaces and thereby form part of a cube.

29. The positioning device according to claim 27, wherein each of the positioning elements corresponds to a platform with a substantially flat platform surface, wherein the respective platform assigned to a pair of legs is arranged substantially perpendicular to its leg elements, wherein the three platforms which are interconnected with each other together form a positioning body in which each of the platform surfaces is arranged substantially perpendicular to the other two platform surfaces and thereby form part of a cube, and wherein the three positioning modules are arranged such that their bases together form a cube-like base body with a recess, and in that within this recess the partial-cube-shaped positioning body is arranged such that the respective corresponding edges of the base body and the positioning body run parallel to one another.
